(19) United States
(12) Patent Application Publication
(10) Pub. No.: US 2023/0274600 A1
(43) Pub. Date: Aug. 31, 2023

(54) METHOD AND DEVICE FOR CHECKING VALUE DOCUMENTS, AND METHOD AND DEVICE FOR GENERATING CHECKING PARAMETERS FOR USE IN A METHOD FOR CHECKING VALUE DOCUMENTS

(71) Applicant: GIESECKE+DEVRIENT CURRENCY TECHNOLOGY GMBH, München (DE)

(72) Inventor: Marja KODEWITZ, Munchen (DE)

(21) Appl. No.: 18/016,528

(22) PCT Filed: Jul. 15, 2021
(86) PCT No.: PCT/EP2021/025263

§ 371 Date: Jan. 17, 2023

(30) Foreign Application Priority Data
Jul. 16, 2020 (DE) 10 2020 004 284.8

(51) Int. Cl. G07D 7/207; G06V 10/75

(52) U.S. Cl. CPC G07D 7/207; G06V 10/751

(57) ABSTRACT

A method is for generating element templates for forming templates when checking value documents of a specified value document type having at least two specified manufacturing elements, which, where applicable, partially overlap each other, and the element templates correspond to the manufacturing elements. Digital training images of training value documents of the specified value document type and a digital reference image of a reference value document of the specified value document type are used, which each have pixels to which pixel data are respectively assigned.

The invention relates to a method and a device for checking value documents and to a method and a device for generating checking parameters for use in the method for checking value documents.

In this context, value documents are understood to mean sheet-shaped objects, which represent for example a monetary value or an authorization and thus shall not be manufacturable at will by unauthorized persons. They hence have features that are not simple to manufacture, in particular to copy, whose presence is an indication of authenticity, i.e. manufacture by an authorized body. Value documents can have different value document types. Important examples of such value document types are coupons, vouchers, checks and in particular bank notes. In the case of bank notes, value document types may be further distinguished; in the context of the present invention, a value document type may be given by the currency and the nominal value of a bank note or the denomination and, where applicable, the issue or the period during which they were officially issued, for example by central banks. Insofar as the following explanations refer to bank notes, they apply accordingly to any other type of value document.

Bank notes are often manufactured by printing a substrate in several steps or manufacturing steps, with a print layer being applied to the bank note substrate in each of the steps. The applied print layers should have specified positions relative to the bank note substrate and/or to each other, but this is usually only approximately the case, as the print layers may be displaced relative to each other due to the manufacturing. As a consequence, variations in the appearance of the bank notes arise.

When checking a value document of a specified value document type, such as when checking the authenticity or the state, in particular a state deterioration due to soiling or removal of printing ink, a digital image of the value document to be checked is often captured and used for checking. In the context of the present disclosure, a digital image is understood to be an image comprising pixels and pixel data associated with each of the pixels. Each pixel corresponds here to a corresponding location in the image for which the pixel data applies. Locations in the image correspond to locations on the value document. The pixel data can, for example, represent brightness or color values of the respective pixels. When checking, depending on the method used, it is checked whether or to what extent the digital image fulfils at least one specified check criterion.

When checking the criterion, checking parameters are used that determine specified properties of value documents of the specified value document type. For example, in some checking methods, when checking the criterion, it may be checked whether pixels or pixel groups have properties established by the checking parameters. The checking parameters can then comprise, for example, a template for value documents of the specified value document type. In the context of the present application, a template is understood to be data which include pixels of at least one portion of a digital image of a value document of the specified value document type and template pixel data assigned to the pixels in each case. Each pixel corresponds here to a corresponding location in the image for which the pixel data applies. The resolution, i.e. the number of pixels related to the area, and their arrangement to each other preferably corresponds to that of the digital image of the security document to be checked of the specified value document type. Depending on the type of template, the template pixel data can comprise at least one single value and/or also a range of values to be regarded as permissible for the pixel data of a value document image to be checked.

So when checking for condition degradation such as soiling or removal of printing ink, as the check criterion, there can be checked whether the pixel data or pixel values for pixels of an image of a value document are within a specified interval for permissible values. If a value is below the interval, it can be concluded that there is soiling, if it is above the interval, a removal of printing ink can be concluded. Otherwise, it is assumed that there is no deterioration for the pixel.

Such templates are created for respectively one value document type, in the case of bank notes, for example, given by the currency and the value or denomination and, where applicable, the issue.

For example, templates are often created by carrying out an averaging over a large number of images of training value documents of the specified value document type so that an average over the corresponding pixel data of the training value documents is used as the template pixel data for a pixel. For other templates, lower and upper limits for the intensity can be established for pixels as template pixel data, which can be given by the minimum and maximum intensity values for the respective pixel over the amount of training value documents.

For arbitrary value documents of the same value document type, there is thus used the same template. However, variations in the position of the print layers lead to inaccurate templates, in particular in the case where interval limits are used.

When checking value documents of the specified value document type, the variations in the position of the print layers described above lead to the fact that these methods may work less accurately, as the templates are not very accurate and/or tolerances must be permitted to compensate for the still permissible displacement of the print layers in relation to each other and thus for the variations in the pixel data accompanying the variation in the displacements.

Similar problems may arise when, for example, manufacturing-related fluctuations in the relative position of other manufacturing elements occur, that determine at least partly the appearance of a value document. In the context of the present application, manufacturing elements (or manufacture elements) are understood to be elements of a value document which determine and/or influence at least partly the appearance of the value document in the visible or non-visible (e.g. IR and/or UV) spectral range, in particular print layers, and are manufactured or applied independently and/or in separate manufacturing steps from other elements, in particular manufacturing elements. Examples of manufacturing elements are print layers applied to a value document substrate by means of gravure printing or offset printing, elements applied to the substrate by means of screen printing, e.g. images or characters with a color dependent on the viewing angle, or optically capturable security elements, such as watermarks introduced into the substrate or embedded security threads, or foils applied to the substrate, e.g. by means of hot stamping method, where applicable with holograms. For ease of reading, the following explanations may partly refer to print layers. However, they apply accordingly to any type of manufacturing element, in particular to the examples of manufacturing elements described above.

The invention is based on the object of stating methods for checking value documents of a specified value document type which have at least two manufacturing elements, and a method for providing checking parameters for the checking method, which allow a simple, accurate check of such value documents. The invention is further based on the object of stating means for carrying out the methods.

The object is achieved by a method for checking value documents and a method for generating element templates for use in checking value documents, each having the features of the corresponding independent method claims, as well as by a device for checking value documents and a device for generating element templates for use in checking value documents, each having the features of the corresponding device claims.

In particular, the object is achieved by a method for checking value documents of a specified value document type, which each have at least two specified manufacturing elements, in particular print layers and/or security elements, using element templates for the manufacturing elements, which comprises the following steps: providing a digital value document image of a value document of the specified value document type to be checked, which comprises pixels which respectively have pixel data assigned thereto; for the provided value document image, ascertaining a position of the manufacturing elements; ascertaining a template for the digital value document image using the element templates for the manufacturing elements and the ascertained positions of the manufacturing elements; and checking the digital value document image using the ascertained template. Depending on the result of the check, a signal can be generated that renders the result of the check. In the following, the method is also referred to as the checking method for short.

The checking method can be carried out in a computer-aided manner. The element templates used in the checking method are preferably provided beforehand, for example stored in a memory of a data processing device or computer by means of which the checking method is carried out.

Subject matter of the invention is also a device for checking value documents of a specified value document type, in particular bank notes that respectively have at least two specified manufacturing elements, in particular print layers and/or security elements, using element templates for the manufacturing elements with an evaluation unit which has at least one memory in which the element templates are stored and an interface for providing a digital value document image, the evaluation unit being adapted to carry out a checking method according to the invention using the stored element templates and the digital value document. In the following, this device is also referred to as checking device.

The evaluation unit can preferably have a processor, which is connected to the memory via a data connection, and a program memory connected to the processor via a data connection, the program memory having stored therein instructions of a program, upon whose execution the at least one processor executes the checking method of the invention using the element templates stored in the memory and the digital value document image. In the context of the present invention, a processor is understood to be not only a single processor with one or more cores, but also a system of coupled processors. The memory, the interface and the processor can form parts of a data processing unit of the evaluation unit.

Subject matter of the invention is hence also a computer program for execution by means of a data processing unit having a processor, which includes program code upon whose execution the processor carries out the checking method of the invention.

Subject matter of the invention is also a computer-readable data carrier on which a computer program of the invention is stored, and in particular a computer program for execution by means of a data processing unit with a processor, which includes program code upon whose execution the processor carries out the checking method of the invention.

In the checking method, for providing the value document image, a digital value document image of a value document to be checked may be captured by means of an image capture unit and stored in a memory unit or a memory. For this, the checking device may further have an image capture unit for capturing a digital value document image of a value document to be checked, which is connected to the interface for providing a digital value document via a signal connection.

In particular, the checking method allows individual value documents to be checked in real time as they are processed.

It is therefore also an object of the present invention to provide methods for processing, in particular checking and/or counting and/or sorting and/or destroying, value documents of a specified value document type which respectively have two specified manufacturing elements, in particular print layers and/or security elements, in which value documents are individually transported past an image capture unit for capturing a digital value document image, a digital value document image is captured during the transport of a respective value document past the unit, and is then checked, preferably in real time, with a checking method according to the invention. Depending on the result of the inspection, the value document can be sorted and/or destroyed.

Subject matter of the present invention is hence also a device for processing, in particular checking and/or counting and/or sorting and/or destroying, value documents of a specified value document type, in particular bank notes which each have at least two specified manufacturing elements, in particular print layers and/or security elements, with a feeding unit for feeding individual or singled value documents to be processed, an output unit with at least one output portion for receiving processed value documents, a transport unit for transporting individual or singled value documents from the feeding unit to the output unit, and a checking device of the invention, wherein the image capture unit of the checking device is arranged at the transport path and is adapted such that digital value documents images of value documents transported past the image capture unit and to be checked are captured during the transport past and are provided for use in the checking device. Preferably, the device can be configured for checking the transported value documents in real time.

The object is further achieved by a method for generating element templates for forming templates when checking value documents of a specified value document type, wherein value documents of the specified value document type have at least two specified manufacturing elements, in particular print layers and/or security elements, wherein in the method digital training images of training value documents of the specified value document type and a digital reference image of a reference value document of the specified value document type, which each have pixels to which pixel data are respectively assigned, are used, having the following steps: for the training images, respectively ascertaining a position of the manufacturing elements, and assigning pixels of the respective training image to the manufacturing elements using the reference image and taking into account the respectively ascertained positions of the manufacturing elements. The method further comprises generating, for each of the manufacturing elements, a first element template which includes those pixels that have been assigned to the respective manufacturing element in all the training images. It further comprises generating a second element template which includes those pixels that have been assigned to the respective manufacturing element in one or more of the training images. The element templates can then be stored, preferably in a memory or computer-readable memory medium. For the sake of simplicity, this method is also referred to as the adaptation method in the following. The value documents can preferably be bank notes. Preferably, the associated element template pixel data for a pixel is ascertained from the pixel data of the respective pixel for at least a part of the training value documents or training images.

The digital training images of training value documents of the specified value document type and the digital reference image of a reference value document of the specified value document type may have been previously provided, for example in a memory.

The adaptation method can preferably be carried out in a computer-aided manner.

Subject matter of the invention is further a device for generating element templates for forming templates when checking value documents of a specified value document type, wherein value documents of the specified value document type have at least two specified manufacturing elements, in particular print layers and/or security elements, which, where applicable partly, overlap each other, with a memory unit for storing digital training images of the specified value document type, a reference image of a reference value document of the specified value document type and preferably generated element templates, wherein the device is configured to carry out an adaptation method of the invention using the training images and the reference image and preferably to store the generated element templates in the memory unit. In the following, this device is also referred to as adaptation device.

The adaptation device may in particular have at least one processor, which is connected to the memory unit via a data connection, and a program memory connected to the processor via a data connection, wherein program code is stored in the program memory, upon whose execution the processor executes the adaptation method of the invention using the training images stored in the memory unit. The processor, the program memory and the memory unit may be parts of a data processing unit of the adaptation unit.

Subject matter of the invention is hence also a computer program for execution by means of a data processing unit having a processor, which includes program code upon whose execution the processor carries out the adaptation method of the invention.

Subject matter of the invention is also a computer-readable data carrier on which a computer program of the invention is stored, and in particular computer program for execution by means of a data processing unit with a processor, which includes program code upon whose execution the processor carries out the adaptation method of the invention.

In the adaptation method, only images of value documents of the specified value document type need to be used. Preferably, here, the training value documents and the reference value document may comprise or are preferably finished and/or freshly printed value documents of the specified value document type, in particular of the same currency and/or denomination. In this way, suitable element templates can be ascertained for the manufacturing elements and from these templates using finished bank notes, without having to make available separate prints of the respective print layers first. This further avoids the difficulties that may arise when these print layers partially overlap in a finished value document but not in the separate prints. Altogether, this enables an easier and more reliable generation of templates. The images used preferably show complete value documents, i.e. in particular value documents that are not damaged or incomplete.

In the checking method, there may be used element templates generated or provided by means of other methods, which are suitable for checking value documents of the specified value document type. Preferably, however, element templates generated by an adaptation method of the invention are used.

Insofar as steps of the methods of the invention do not use results from other steps, these may be executed in whole or in part in parallel or interleaved or in any arbitrary order.

The methods use digital images of value documents of a specified value document type. These images preferably have the same resolutions and thus the same number of pixels for a specified imaged area. Preferably, they show the same portions of the respective value document, particularly preferably the entire value document, very particularly preferably only the entire value document. The pixels may here be identified by their place in the image or corresponding place data or by the type and/or order in the memory. The pixel data may comprise data which in the case of images render brightness values and/or color values and/or intensity values in specified wavelength ranges, for example in the infrared.

Value documents of the specified value document type have the at least two specified manufacturing elements that are visible at least partly and thus depicted in the images. The manufacturing elements may partially overlap, where applicable. The value documents may still have further manufacturing elements, which, however, are not explicitly considered in the methods of the invention.

In the methods, element templates are generated or used for the manufacturing elements, which respectively correspond to the manufacturing elements. Element templates within the meaning of the present disclosure include, like templates, pixels and element template pixel data respectively assigned to the pixels. With regard to the pixels, the explanations on templates apply accordingly. The element template pixel data, analogous to templates, may include, depending on the type of element template, at least one single value and/or also data which define a range of values to be considered permissible for the pixel data of a pixel of the element template. However, an element template for a manufacturing element can preferably include fewer pixels than a digital image of an entire value document, as it only needs to correspond to the manufacturing element which does not need to extend over the entire surface of a value document.

The element templates and the template to be generated in dependence on these have to be suitable for the checking method for an individual value document which uses the template.

The element templates are respectively assigned to the manufacturing elements. Depending on the position of the manufacturing elements ascertained in the checking method for a value document currently being checked, an individual template can be generated for the value document to be checked in dependence on the element templates, which individual template is used in the further checking. The template can therefore only be ascertained during the checking method in real time and thus “dynamically”, so to speak. This can greatly reduce or eliminate the inaccuracies which are caused by fluctuations in the position of the manufacturing elements. Furthermore, when comparing the value document image with the individual template, methods known in the art can be used which use a template, but where permissible tolerances can be or are reduced. This is not necessary, however.

In the adaptation method, two element templates are generated for each of the manufacturing elements. However, the element templates for a manufacturing element are preferably only generated if corresponding pixels have been ascertained at all.

The first element template for a respective one of the manufacturing elements includes those pixels that could be assigned to the manufacturing element for all training images. Preferably, it includes only these pixels. It can therefore be assumed that these always correspond to at least one portion of the respective manufacturing element and always largely or completely determine the appearance in the corresponding image regions. They can therefore also be referred to as “dominant”. Different first element templates therefore do not include the same pixels. In this respect, the pixels of a respective first element template may correspond to a mask by means of which pixels corresponding to the manufacturing element can be identified. The masks then do not overlap.

The second element template includes those pixels to which the respective manufacturing element has been assigned in at least one of the training images. Therefore, the pixels of the first element template for a manufacturing element preferably form a subset of the pixels of the second element template for the same manufacturing element. However, the case may occur that a pixel is included in second element templates for two different manufacturing elements. In these cases, among the training images or training value documents, there was at least one in which one of the manufacturing elements was offset with respect to the same manufacturing element of another one of the training value documents in such a way that on one occasion an assignment to the one manufacturing element and on the other occasion an assignment to the second manufacturing element was made. At these points the manufacturing elements may overlap. Therefore, since such a pixel cannot be assigned to only one of the manufacturing elements, it must be treated differently when creating the template using the element templates.

The use of these two element templates for the same manufacturing element has the advantage that, for example in the case of a print layer, portions of the print layer that are always covered by other elements and not visible are not present in the templates. Portions of a print layer that only influence the appearance depending on the positions of the print layers in the training images are taken into account in the second element template, those that are always present in the training images in the first element template. Not only does the print layer, as applied in one step of the manufacturing, not need to be known exactly, but also the proportions that do not contribute to the appearance in the training value documents, depending on their contribution, are not taken into account in the element templates. Even from a full-area print layer, which, however, only contributes in part to the appearance in the training images, this proportion can be ascertained. This leads to more accurate element templates and subsequently ascertained individual templates therefrom.

The element templates generated by the method can preferably be used in the checking method of the invention.

In the checking method, it is then preferred that for at least one of the specified manufacturing elements, preferably for the specified manufacturing elements, a first and a second element template is used, wherein, when ascertaining the template, to pixels which are present in the first element templates displaced in accordance with the ascertained positions of the manufacturing elements, template pixel data are assigned which were ascertained using element template pixel data of the respective pixels in the first element templates displaced according to the ascertained positions of the manufacturing elements, and for the remaining pixels which are present in at least one of the second element templates displaced in accordance with the ascertained positions of the manufacturing elements, template pixel data is ascertained using the element pixel data of respective corresponding pixels of the at least one of the second element templates displaced in accordance with the ascertained positions of the manufacturing elements. If a pixel is present in second element templates for two manufacturing elements, the template pixel data is thus determined in dependence on the pixel data of the second element templates. Preferably, the first element templates for different manufacturing elements do not include identical pixels, while the second element templates for different manufacturing elements may include identical pixels but have different element pixel data assigned thereto. The first and second element templates are preferably element templates ascertained by an adaptation method according to the invention.

Preferably, if a pixel is present in only one of the displaced element templates, the template pixel data used is the element template pixel data of the respective pixel of the respective displaced first element template. If, on the other hand, a pixel is present in more than one of the first element templates, the template pixel data is ascertained using the element template pixel data of the displaced first element templates. This procedure has at least two advantages: on the one hand, the pixels that are included in the first partial templates and whose properties are therefore determined by the respective manufacturing element and which are “dominant” for the appearance can be clearly identified, and corresponding, more accurate template pixel data can be assigned. This allows for clear contours of these regions. Since, when creating the individual templates, pixels or pixel data of the second element templates are only assigned to pixels that are not present in the first element templates, the template pixel data for these can be ascertained depending on the element template data of the element templates. This also leads to improved accuracy of the individual template.

The manufacturing elements, depending on the value document type, need not extend over the entire value document, either alone or in combination. In the adaptation method, it may then happen that pixels for none of the training images can be assigned to one of the manufacturing elements. Then it is possible that the element templates, even in combination, are not sufficient to generate an individual template for the entire value document.

In the adaptation method, it is therefore preferred that the method comprises as a further step a generation of a background template which includes those pixels that have not been assigned to any of the manufacturing elements in any of the training images and background template pixel data assigned thereto respectively, wherein the background template pixel data is preferably ascertained from pixel data being assigned to the respective pixels of the training images. The background template is ascertained for the specified value document type and includes, in particular, information, i.e. pixels and, if applicable, pixel data assigned to the pixels, on areal regions of the value document that are not determined by the optical appearance of the present manufacturing elements, for example print layers or security elements, i.e. substantially the background. The background template can be stored like the element templates.

The checking method may then preferably use a background template which includes pixels, which are not included in any of the element templates for the manufacturing elements, and background template pixel data respectively assigned thereto. When ascertaining the template for the digital value document image, respective template pixel data can then be ascertained for the remaining pixels that have not been assigned template pixel data of element templates and that are present in the background template, using the background template pixel data of a respective corresponding pixel of the background template. The background template can be stored in the same way as the element templates. Preferably, the background template is coordinated to the element templates, particularly preferably, it has been generated with an adaptation method of the invention.

These embodiments have the advantage that an individual template for a value document image generated in this way also includes pixels with pixel data that are not included in any of the first and/or second element templates. In particular, it is possible to generate an individual template for a value document for the entire area of the value document.

In both methods, respectively one position of the manufacturing elements is ascertained. For this, arbitrary methods can be used. For example, for each of the manufacturing elements, at least one so-called anchor element and an anchor point rendering its place can be specified. The anchor element can preferably be an image portion characteristic of the manufacturing element, for example a character or another distinctive print image detail, which is present in images of value documents of the specified value document type, i.e. in particular in the training images and the reference image. Such anchor elements may have been selected automatically and/or manually. In the images, the anchor elements or the positions of the anchor points can be ascertained by means of template matching or other correlation methods. In order to be able to establish the position of the manufacturing elements, at least two anchor elements are preferably specified for each of the manufacturing elements. Particularly preferably, the first element templates for the manufacturing elements respectively include the corresponding anchor elements for these manufacturing elements.

In principle, it is sufficient that when ascertaining the position of the respective manufacturing elements in a respective one of the training images and/or the reference image, the positions of the manufacturing elements in the training images or the reference image are ascertained with respect to a positional reference system which can be particularly preferably determined by elements of the value document in the image, for example by an outline or edges of the value document in the respective training image or reference image, or the edges or an edge and a corner point of the training image or reference image. Preferably, the ascertained positions of the manufacturing elements in the training images are positions relative to the positions of the corresponding manufacturing elements in the reference image. This facilitates the later generation of a template when carrying out a checking method according to the invention. As a result, in particular position data can be generated, from which the position of the manufacturing elements relative to a positional reference system, for example the one mentioned above, can be ascertained. For example, the positions may relate to a specified corner of the value document and one or two adjacent edges. The element templates may also preferably include implicitly, for example by the way they are stored, or explicitly position data rendering the position of the manufacturing elements in the reference image, in particular with respect to the positional reference system. This can be done in the case that the element templates do not comprise all the pixels of an image of a value document by establishing a specified pixel of the element template. However, it is also possible to use the position of an anchor point.

In the checking method, when generating the template, also the ascertained positions of the manufacturing elements are used. The explanation for ascertaining the position in the adaptation method applies accordingly. Thus, when ascertaining the position of the respective manufacturing elements in a value document image, this position is preferably ascertained with respect to a positional reference system that corresponds to the one used when generating the element templates. The element templates can then be offset or displaced in accordance with a difference of the position of the manufacturing elements in the value document image of the position of the manufacturing elements according to the position data in the element template.

It is understood that the explanations on the indication of the positions also apply to the background template, as far as this is generated or used.

The adaptation method tries, for each training image, to assign pixels to one of the manufacturing elements. Since their position can vary between different value documents, the positions of the manufacturing elements ascertained for the training image are taken into account when assigning them.

For this, in a preferred embodiment, when assigning pixels of the respective training image to the manufacturing elements for a respective pixel of the respective training image, a degree of match between a pixel environment of the pixel and a pixel environment of a corresponding pixel in the reference image can be ascertained, wherein the respective pixel environments of the respective pixel in the training image and in the reference image are displaced or offset in accordance with the respective relative position of the respective manufacturing element in the training image to that in the reference image, and the respective pixel of the training image is assigned to one of the manufacturing elements in dependence on the ascertained match degrees according to a specified assignment criterion. In the context of the present disclosure, a pixel environment of a pixel is understood to be a set of pixels which comprise the pixel and pixels within a specified distance from the pixel. The distance determines the size of the pixel environment, i.e. the number of pixels in the pixel environment.

The assignment criterion can preferably be specified such that an assignment is made to that of the manufacturing elements for which the degree of match is the greatest. Particularly preferably, an assignment is only made if the degree of match for the manufacturing element with the greatest match exceeds a specified minimum value. This can preferably be specified such that only weak and, where applicable, random, non-significant matches do not lead to an assignment to a manufacturing element. This has the advantage that the element templates become more accurate.

As element template pixel data there can be assigned to the pixels, which are ascertained from pixel data which are assigned to the respective pixels of the training images, or correspond to the pixel data which are assigned to the respective pixels of the training images. In particular, the element template pixel data can be arbitrary functions of the pixel data of the pixel data assigned to the respective manufacturing element in the training images. For example, one pixel datum may be an average value over the mentioned pixel data or, in another embodiment, the pixel data may comprise, as lower and upper limits of an interval for permissible values, the minimum and the maximum, respectively, of the pixel data of the mentioned pixels.

In the checking method, it is then preferred that, when ascertaining the template, pixels of the template that are present in the element templates displaced or offset in accordance with the ascertained positions of the manufacturing elements are respectively assigned template pixel data that are ascertained for the manufacturing elements in dependence on element template pixel data of corresponding pixels of element templates displaced in accordance with the respectively ascertained positions.

In another embodiment of the adaptation method, two assignments can be made when assigning the pixels. More specifically, when assigning pixels of the respective training image to the manufacturing elements, for a respective pixel of the respective training image there can be ascertained a first degree of match between a first pixel environment of the pixel and a first pixel environment of a pixel in the reference image, wherein the first pixel environments in the training image and in the reference image are offset, in accordance with the respective relative position of the respective manufacturing element in the training image, to that in the reference image; the respective pixel of the training image can then be assigned, in a first assignment, to one of the manufacturing elements in dependence on the ascertained first match degrees according to a specified first assignment criterion. Further, for a respective pixel of the respective training image, a second degree of match between a second pixel environment of the pixel and a second pixel environment in the reference image may be ascertained, wherein the second pixel environments in the training image and in the reference image are offset, in accordance with the respective relative position of the respective manufacturing element in the training image, to that in the reference image; the respective pixel of the training image can then be assigned, in a second assignment, to one of the manufacturing elements in dependence on the ascertained second match degrees according to a specified second assignment criterion. Preferably, the second pixel environments respectively comprise more pixels than the first pixel environments, i.e. are preferably larger.

In both cases, the degree of match can be determined as explained above. The assignment criteria can be chosen as described above, but the minimum values for the two criteria can be selected to be the same or different.

If two assignments have been made, in the adaptation method, the first element template for the respective manufacturing elements may include only those pixels which have been assigned to the respective manufacturing element in all the training images in the first assignment, and the second element template for the respective manufacturing elements may include, preferably only, those pixels which have been assigned to the respective manufacturing element in at least one of the training images in the second assignment. This embodiment has the advantage that the first element template includes as accurate as possible those pixels that are always visible on value documents of the specified value document type.

This has the advantage that the first element templates correspond quite exactly to the dominant, i.e. always visible in all training images, portions of the respective manufacturing elements. However, the second element templates also include proportions of manufacturing elements that are only recognizable in certain positions in the training images. For their identification, the use of larger pixel environments is more advantageous, as then an assignment can be made more frequently.

The element templates respectively include not only the pixels, but also the element template pixel data respectively assigned to them. Preferably, in the adaptation method, when generating the element templates, first element template pixel data is assigned to the pixels included in the first element template and second element template pixel data is assigned to the pixels included in the second element template, wherein the first and/or second element template pixel data is ascertained from pixel data assigned to the respective pixels of the training images or corresponds to the pixel data assigned to the respective pixels of the training images. In particular, the element template pixel data can be arbitrary functions of the pixel data of the pixel data assigned to the respective manufacturing element in the training images. For example, one pixel datum may be an average value over the mentioned pixel data or, in another embodiment, the pixel data may comprise, as lower and upper limits of an interval for permissible values, the minimum and the maximum, respectively, of the pixel data of the mentioned pixels. The same applies to the pixel data of the background templates. This procedure has the advantage that the pixel data of the element templates are ascertained from many training value documents and are therefore more accurate.

In the checking method, a first and a second element template can then preferably be used for at least one of the manufacturing elements, wherein, when ascertaining the template, to pixels of the template, which are present in the first element templates displaced in accordance with the ascertained positions of the manufacturing elements, as template pixel data the element template pixel data of the first element templates displaced in accordance with the ascertained positions of the manufacturing elements are assigned, for the remaining pixels which are present in at least one of the second element templates displaced in accordance with the ascertained positions of the manufacturing elements, template pixel data is ascertained using the element template pixel data of a respectively corresponding pixel of the at least one of the second element templates displaced in accordance with the ascertained positions of the manufacturing elements.

The invention will hereinafter be explained further by way of example with reference to the drawings. There are shown:

FIG. 1 a schematic representation of a value-document processing device, in the example of a bank-note sorting device,

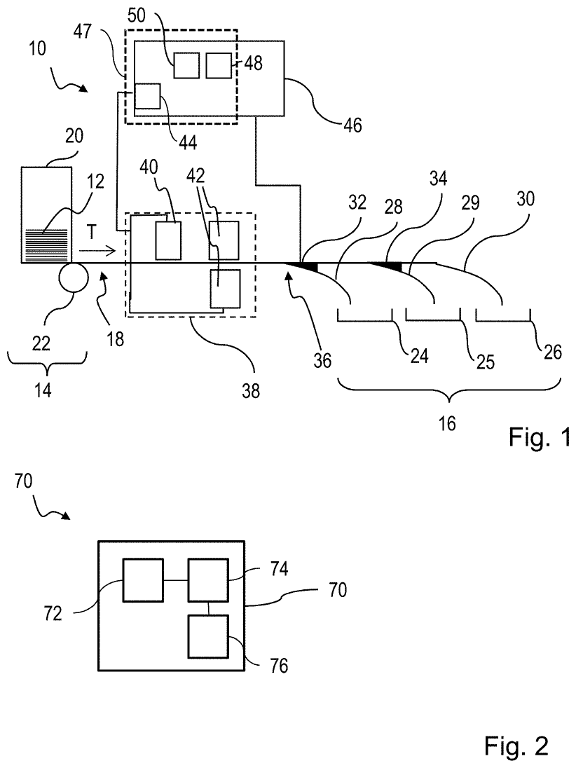

FIG. 2 a very schematic representation of a device for generating element templates,

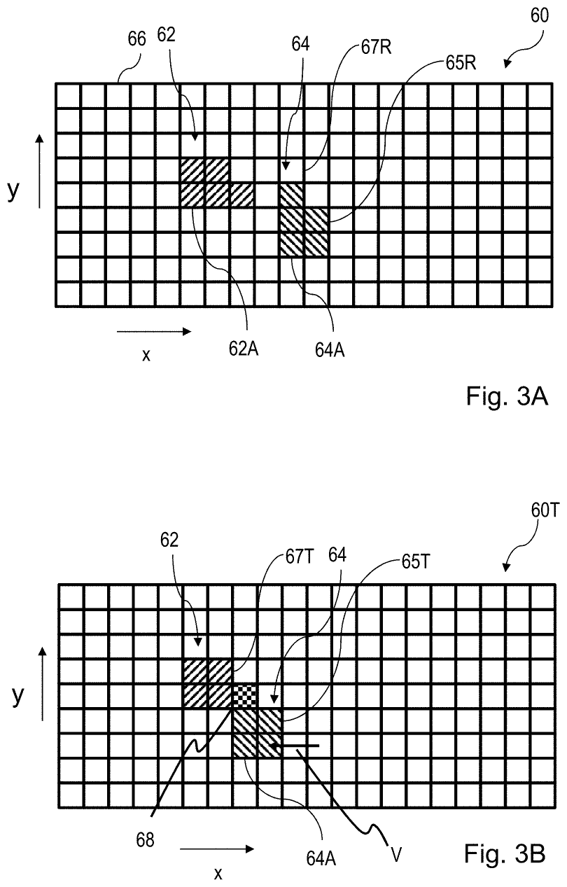

FIG. 3A, B very schematic representations of value document images of value documents having different positions of manufacturing elements,

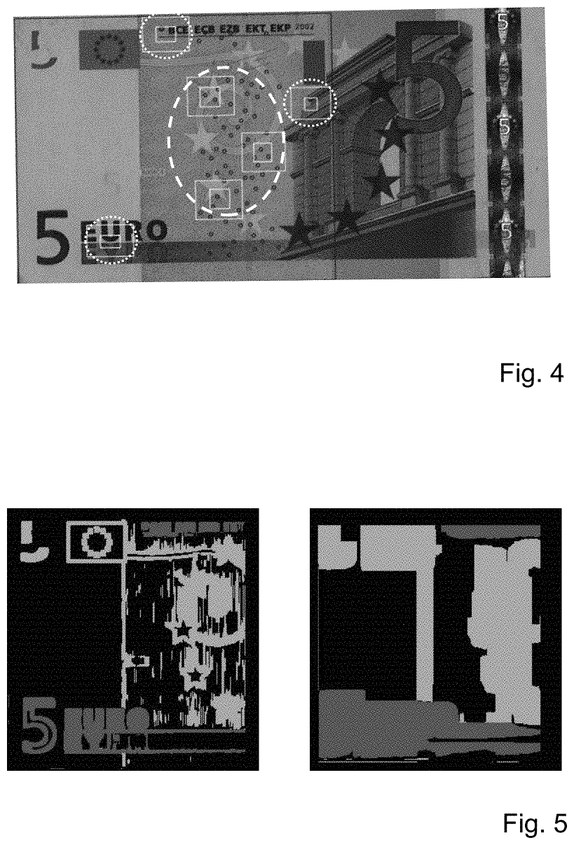

FIG. 4 an example of an image captured from a value document of a specified value document type,

FIG. 5 respectively one example of an assignment of pixels for a value document in FIG. 4 made in a smaller pixel environment (left) and a larger pixel environment (right),

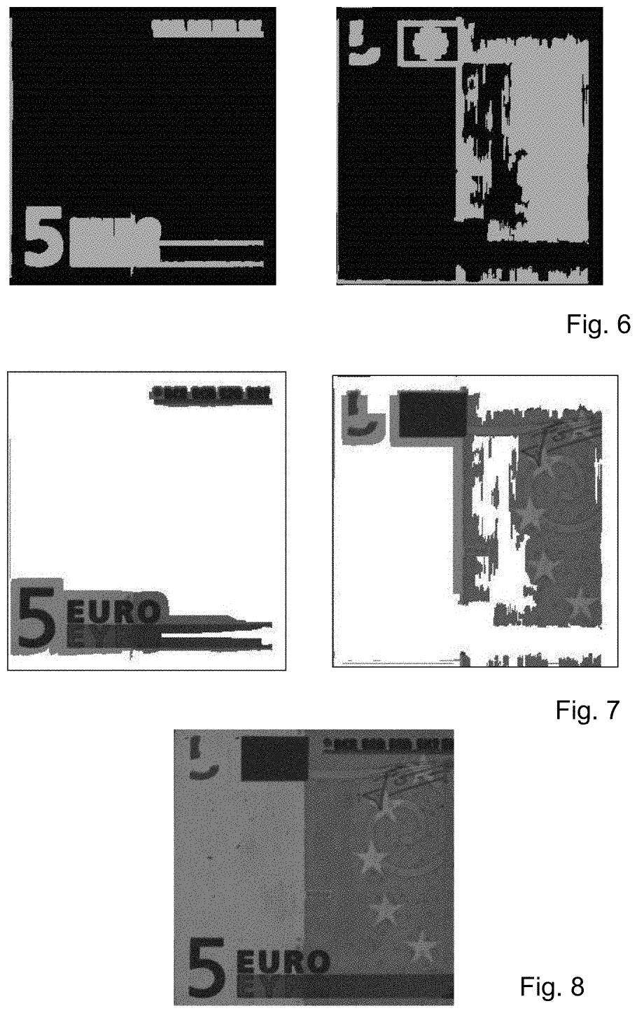

FIG. 6 respectively one example of a first element template for the first print layer (left) and the second print layer (right) for value documents of the value document type as in FIG. 4,

FIG. 7 respectively one example of a second element template for the first print layer (left) and the second print layer (right) for value documents of the value document type as in FIG. 4,

FIG. 8 an example of an individual template composed of element templates for a value document of the value document type as in FIG. 4,

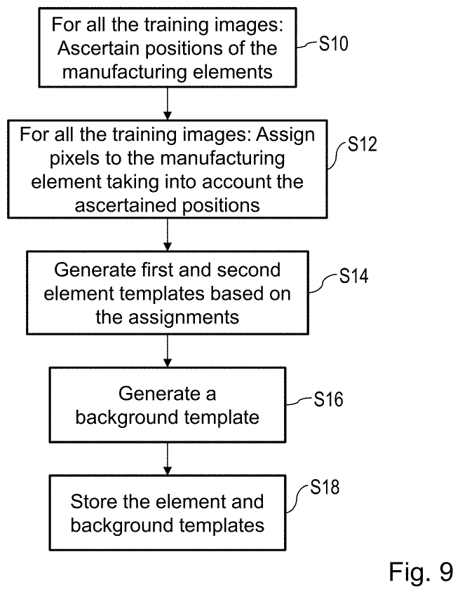

FIG. 9 a very schematic flowchart for an example of an adaptation method for generating element templates,

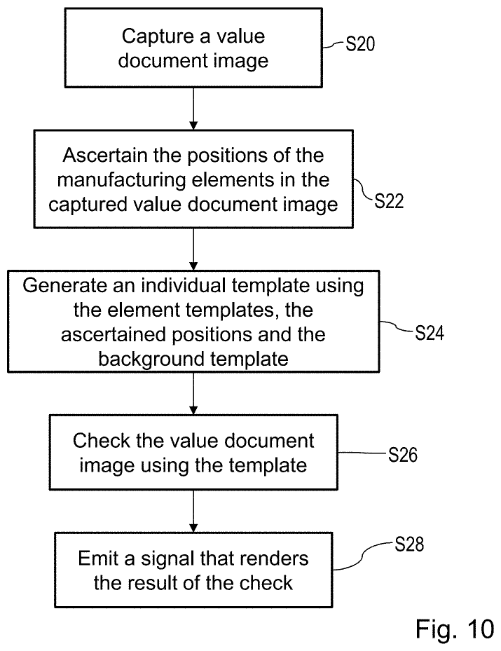

FIG. 10 a very schematic flowchart for an example of a checking method for value documents of the specified value document type, in which element templates are used which are generated with the method according to FIG. 9, and

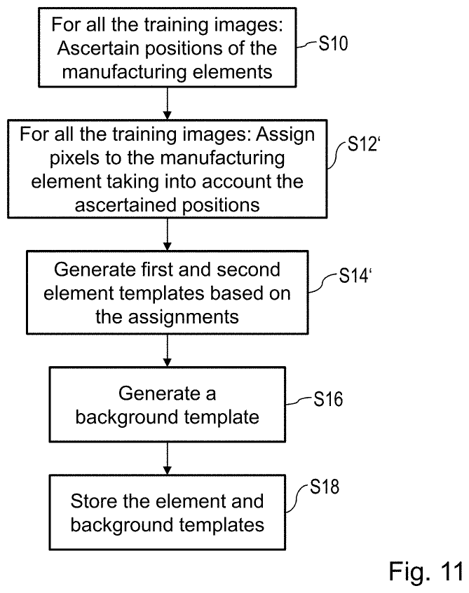

FIG. 11 a very schematic flowchart for another example of an adaptation method for generating element templates.

A value-document processing device 10 in FIG. 1, in the example a device for processing value documents 12 of a specified value document type in the form of bank notes, is configured for sorting value documents 12 in dependence on the state ascertained by means of the value-document processing device 10 and of the authenticity of processed value documents checked by means of the value-document processing device 10.

It has a feeding unit 14 for feeding value documents 12, an output unit 16 for delivering or receiving processed, i.e. sorted, value documents, and a transport unit 18 for transporting singled value documents from the feeding unit 14 to the output unit 16.

The feeding unit 14 in the example comprises an input pocket 20 for a value-document stack and a singler 22 for singling value documents 12 out of the value-document stack in the input pocket 20 and feeding singled value documents to the transport unit 18.

The output unit 16 in the example comprises three output portions 24, 25 and 26 into which processed value documents can be sorted depending on the intermediate result of the processing, in the example a check. In the example, each of the portions comprises a stack pocket and a stacking wheel (not shown) by means of which fed value documents can be deposited in the stack pocket. In other embodiment examples, one output portion may be replaced by a unit for destroying bank notes.

The transport unit 18 has at least two, in the example three, branches 28, 29 and 30 at whose ends respectively one of the output portions 24 or 25 or 26 is arranged, and, at the branching points, gates 32 and 34 controllable by actuating signals, by means of which value documents are feedable to the branches 28 to 30 and thus to the output portions 24 to 26 in dependence on actuating signals.

At a transport path 36, defined by the transport unit 18, between the feeding unit 14, in the example more precisely the singler 22, and the first gate 32 after the singler 22 in the transport direction T there is arranged a sensor unit 38 which captures physical properties of the value documents when value documents are being transported past and which forms sensor signals rendering the capture results which represent sensor data. In this example, the sensor unit 38 has an image capture unit 40 with an optical remission sensor that captures a remission color image of the value document, and other sensors 42, symbolized only by boxes, for physical properties of a value document.

A control and evaluation unit 46 is connected via signal connections to the sensor unit 38 and the transport unit 18, in particular the gates 32 and 34. In connection with the sensor unit 38 it classifies a value document in dependence on the signals or sensor data of the sensor unit 38 for the value document into one of specified sorting classes. These sorting classes can be specified, for example, in dependence on a state value ascertained by means of the sensor data and in dependence on an authenticity value also ascertained by means of the sensor data. As state values, for example, the values “fit for circulation” or “not fit for circulation” can be used, as authenticity values the values “forged”, “suspect” or “authentic”. In dependence on the ascertained sorting class, it controls by emitting actuating signals the transport unit 18, here more precisely the gates 32 or 34, such that the value document is outputted, in accordance with its sorting class ascertained in the classification into an output portion of the output unit 16, said portion being assigned to the class. The assignment to one of the specified sorting classes or the classification is effected here in dependence on criteria specified for the judgement of the state and the judgement of the authenticity, which criteria depend on at least a part of the sensor data.

The control and evaluation device 46 has for this purpose in particular, besides at least one corresponding interface 44 for the sensor unit 38 or the sensors thereof, in particular of the image capture unit 40, a processor 48 and a memory 50 connected with the processor 48, in which memory at least one computer program with program code is stored, upon whose execution the processor 48 controls the device, and evaluates the sensor signals of the sensor unit 38, in particular for ascertaining a sorting class of a processed value document. Furthermore, program code is stored therein, upon whose execution the processor 48 controls the device and, according to the evaluation, drives the transport unit 18.

The interface 44, the processor 50 and the memory 48 or a portion of the memory 48 in which a corresponding computer program and method parameters are stored form an evaluation unit 47 within the meaning of the present disclosure. In this example, the evaluation unit 47 evaluates the signals of the remission sensor 40 separately from those of the other sensors. The processor 50 and other portions of the memory 48 may also perform other functions in addition, for example, controlling the value document processing device 10.

The remission sensor 40 is configured to capture an RGB remission image of a value document as it is transported past the remission sensor 40 by means of the transport unit 18, and to generate a digital image therefrom which is evaluated by the evaluation unit 47.

In dependence on the value document properties, the control and evaluation unit 46, precisely the evaluation unit 47, respectively ascertains, using the sensor data of the different sensors in partial evaluations, whether or not the ascertained value document properties represent an indication of the state or the authenticity of the value document. Subsequently, corresponding data can be stored in the control and evaluation device 46, for example in the memory 50, for later use. In dependence on the partial evaluations, the control and evaluation unit 46 then ascertains, as an overall result for the check according to a specified overall criterion, a sorting class and forms the sorting or actuating signal for the transport unit 18 in dependence on the ascertained sorting class.

For processing value documents 12, value documents 12 inserted into the input pocket 20 as a stack or singly are singled by the singler 22 and fed in singled form to the transport unit 18, which transports the singled value documents 12 past the sensor unit 38. The latter captures the properties of the value documents 12, sensor signals being formed which render the properties of the respective value document. The control and evaluation device 46 captures the sensor signals or sensor data, ascertains in dependence thereon a sorting class, in the example a combination of an authenticity class and a state class, of the respective value document, and controls the gates in dependence on the result such that the value documents are transported in accordance with the ascertained sorting class into an output portion assigned to the respective sorting class.

The evaluation unit 47 together with the image capture unit 40 form an example for a checking device for checking value documents of a specified value document type which respectively have two specified manufacturing elements, in particular print layers and/or security elements. Accordingly, the computer program includes instructions for executing a method for checking value documents of a specified value document type, in particular bank notes, which respectively have two specified manufacturing elements, in particular print layers and/or security elements, using element templates for the manufacturing elements, in particular generated by means of an adaptation method described in the following. In the checking method, a digital value document image of a value document to be checked is captured by means of the remission sensor 40 and provided in the evaluation unit 47 in a corresponding portion of the memory 50. For the provided value document image, positions of the manufacturing elements are ascertained and a template for the digital value document image is ascertained in real time using at least two of the element templates for the manufacturing elements and the ascertained positions of the manufacturing elements as well as, in this example, a background template. Thereafter, the digital value document image is checked using the ascertained template.

For providing element templates, there serves an adaptation device shown very schematically in FIG. 2, i.e. a device 70 for generating element templates for forming templates when checking value documents of a specified value document type, wherein value documents of the specified value document type have at least two specified manufacturing elements, in particular print layers and/or security elements, which, where applicable, partially overlap each other. The device is a data processing unit with a memory unit 72 for storing digital training images of the specified value document type, a reference image of a reference value document of the specified value document type and preferably generated element templates. The device 70 is configured to carry out an adaptation method described below using the training images and the reference image, and to store the generated element templates in the memory unit 72. For this, the device may have at least one processor 74 which is connected to the memory unit 72 via a data connection, and a program memory 76 which is connected to the processor 74 via a data connection and in which program code is stored, upon whose execution the device executes, by means of the processor 74, the adaptation method described below using the training images stored in the memory unit 72. In other embodiment examples, the program memory 76 may also be formed by a portion of the memory unit 72. The adaptation device 70 may further have a data interface, for example a network card, not shown in the Figure, through which generated element templates stored in the memory unit 72 may be transmitted to another device.

An example of a digital image 60 of a value document 12 of a specified value document type having two specified manufacturing elements 62 and 64 in the form of print layers is shown very schematically in FIG. 3A. The value document is used as a reference value document so that the value document image represents a reference image.

The digital image 60 includes pixels 66, which in the example are arranged on a square grid and represent locations in the digital image and thus on the imaged value document. The image is pre-processed in such a way that it only represents the value document 12 over the full area, i.e. the edges of the value document in the image run along the corresponding edge pixels. This pre-processing, in this example, is carried out for all images so that the images contain corresponding representations.

Shown are, marked by different patterning, two regions 62 and 64 which show the different manufacturing elements, in the example print layers, which do not overlap in this example.

FIG. 3B shows very schematically a digital image 60T of another value document of the specified value document type. In the value document, the manufacturing element 64 or, in the example, the corresponding print layer is offset by a vector V relative to the edges of the value document and thus in the image relative to that in FIG. 3A. The manufacturing element 64 is therefore also positioned differently relative to the manufacturing element 62 than in FIG. 3A. Accordingly, the regions showing or corresponding to the manufacturing elements 62 or 64 are offset relative to those in FIG. 3A. In addition, the print layers overlap so that a corresponding pixel 68 shows a different appearance, symbolized in the figure by a different hatching.

An example of a training image of a value document in the form of a bank note, more precisely a 5 Euro banknote, is shown in FIG. 4. In the present example, the captured image shows, among other things, a first print layer generated by means of steel engraving gravure printing (among others, “5 Euro” and “BCE ECB EZB . . . ”) and a second print layer generated by means of offset printing (among others, stars and small rings).

For generating element templates, the following exemplary adaptation method is used, which is very schematically illustrated in FIG. 9.

In the adaptation method, digital training images of training value documents of the specified value document type and a digital reference image of a reference value document of the specified value document type are used. In the example, finished and clean, preferably freshly printed value documents of the specified value document type are used for this, which preferably have variations in the position of the manufacturing elements. Preferably, the value documents also include those with great differences in the position of the manufacturing elements.

The training images and the reference image can, for example, be captured with the processing device 10 described, in particular the remission sensor 40, for which purpose the digital images fed to the evaluation unit 47 are stored. These can be transmitted to the adaptation device 70 by means of a memory medium or via a data connection not shown and stored there in the memory unit 72 and thus be provided. The digital images respectively have the same pixel numbers and pixel arrangements and show the entire value document.

In step S10, for each of the training images and preferably the reference image, a position of the manufacturing elements is ascertained.

The positions are ascertained with respect to the same positional reference system, which is given by the edges of the value document in the image or, since the image only shows the entire value document, by the edges of the image or corresponding axes.

For ascertaining the positions, in the present example, anchor regions 62A and 64A are used which were previously established for value documents of the specified value document type and are characteristic for the manufacturing element and, in particular, are always visible. In this embodiment example, respectively only one anchor region is used to simplify the representation, in other embodiment examples, preferably at least two or more anchor regions are used for each of the manufacturing elements. The anchor regions usually contain several pixels, but for simplicity's sake they are represented by only one pixel in the very schematic FIGS. 3A and 3B. The anchor regions can be searched for in the digital images using methods that are known in the art. As the position of the anchor region, the mean value over the locations of the pattern can be used in the present example to establish the position.

In the value document image shown in FIG. 4, anchor points or the associated regions are marked by respectively two rectangular shapes lying one above the other. To illustrate their association to the respective print layer, anchor points of the first print layer are surrounded by dotted lines and anchor points of the second print layer are surrounded by dashed lines.

In the present example, the position is described by a position vector in a rectangular coordinate system with axes parallel to the edges of the value document, the first component of which is the x-coordinate of the pixel and the second coordinate of the y-pixel.

In the following step S12, for the respective training images, pixels are assigned to the manufacturing elements or manufacturing elements are assigned to pixels, wherein the reference image is used and the position of the manufacturing elements is taken into account in the training images.

In the example, for each of the training images, the following sub-steps are carried out for each of the specified manufacturing elements:

To take the position into account, a displacement vector is ascertained for the respective manufacturing element, which corresponds to the difference of the ascertained position of the respective manufacturing element in the training image and the position of the respective manufacturing element in the reference image or the difference of the position vectors.

For the assignment of pixels, a specified pixel environment of a respective pixel in the respective training image is compared with a specified pixel environment of a corresponding pixel of the reference image, the position of a respective manufacturing element being taken into account. The pixel environments for a pixel are defined the same in each case.

In the example, this is done by comparing the pixel environment around the respective pixel in the respective training image with the corresponding pixel environment of the corresponding pixel in the reference image under the hypothesis that the respective pixel in the training image belongs to one of the manufacturing elements. This means that the pixel environment of the pixel in the training image is compared with a pixel environment of a corresponding pixel in the reference image, wherein the difference in the positions of the pixel environments in the training image and in the reference image corresponds to the displacement vector, i.e. the difference of the position of the respective manufacturing element in the training image and that in the reference value image.

In relation to the training image, this means that for a given one of the manufacturing elements, the training image is displaced or offset relative to the reference image by the displacement vector but in the opposite direction, i.e. in the direction and by a distance, which is given by the difference in the positions of the manufacturing element in the training image and that in the reference value image, and pixel environments and pixels in the displaced training image and the reference image are compared.

The comparison is made by ascertaining a match degree of the pixel properties of the pixels of the pixel environments. For each pixel environment of a respective pixel, for example a 5×5 pixel environment of the respective pixel including the pixel itself, for example a degree of match of the pixel data for the pixel environment in the displaced training image with those in the reference image is ascertained; in the example, a 2D correlation for the pixel data of the pixel environment with the pixel is ascertained as the match degree.

In the examples in FIGS. 3A and 3B, the displacement of the anchor points 64A for the manufacturing element 64 is two pixels to the left in the x-direction, and the displacement vector V has only component that is not zero. In the comparison, there is thus compared, for example, the pixel 65T and its pixel environment in the training image in FIG. 3B with the pixel and its pixel environment in the reference image that is displaced against the displacement vector V, i.e. by —V; this is pixel 65R in FIG. 3A. If the pixels belong to the same manufacturing element, there results a very good or perfect match, but otherwise not: for example, the pixel 67T displaced against the displacement vector V and its surroundings do not match the pixel properties of pixel 67R and its surroundings in the reference image.

After these match degrees have been ascertained for each of the specified manufacturing elements, it is then decided by means of an assignment criterion, in dependence on the ascertained match degrees, whether the pixel can be assigned to one of the manufacturing elements and, if so, to which of the manufacturing elements. The assignment criterion in the present example is to assign that manufacturing element that has the highest degree of match. However, this assignment is only made if the match degree exceeds a specified minimum value. If this is not the case, an assignment of a manufacturing element is not made.

In the following step S14, for each of the manufacturing elements, a first element template and a second element template are generated.

This is done in such a way that the first element template for the respective manufacturing element includes those pixels that were assigned to the respective manufacturing element in all the training images. The element template pixel data for the pixel is ascertained depending on the corresponding pixel data of the training images. For a soiling check, for example, as pixel data there can be established lower and upper limits for permissible pixel data values, which result from the minimum and maximum, respectively, of the corresponding pixel data of the corresponding pixels in the training images.

For each of the manufacturing elements, a second element template is generated such that it includes those pixels that were assigned to the respective manufacturing element in one or more training images. Here too, the element template pixel data for the pixel can be ascertained in dependence on the pixel data for corresponding pixels in the training images in which the assignment was found. In a soiling check, for example, as pixel data there can be established lower and upper limits for permissible pixel data values, which are ascertained from the minimum and maximum, respectively, of the corresponding pixel data of the pixels in the training images.

In step S16, a background template is generated that includes those pixels that are not included in any of the element templates, in particular none of the first and second element templates. These are assigned data as pixel data, which is ascertained using the pixel data of corresponding pixels in the training images. In a soiling check, for example, as pixel data there can be established lower and upper limits for permissible pixel data values, which result from the minimum and maximum, respectively, of the corresponding pixel data of the pixels in the training images.

In step S18, in this example, the element templates and the background template or corresponding data are stored in the memory 72. They can also be transmitted by means of a mobile memory or via a data connection to another device, which then preferably stores and particularly preferably uses them.

In the operation of the device 10, in the example, a checking method for checking value documents of the specified value document type is carried out. For this purpose, element templates, in this example the element templates ascertained with the previously described method, and, in this embodiment example in the same memory 48, instructions of a computer program are stored in the evaluation unit 47 in the memory 48, upon whose execution the checking method is carried out by the evaluation unit or its processor. For the checking method, the ascertained element templates are stored in the memory 48. The checking method is carried out in real time, with the value documents being transported past the image capture unit 40 at a rate of more than 25 value documents per second, preferably more than 30 value documents per second.

The checking method uses respectively two element templates for the manufacturing elements and one background template. These are generated with the adaptation method described above.

A first element template for a manufacturing element, in the example a print layer, defines which pixels of an image of a value document 12 to be checked are to be uniquely assigned to this manufacturing element, in the example of this print layer, and which element template pixel data are to be used for the respective pixels of an individual template to be generated.

A second element template for a manufacturing element, in the example a print layer, establishes which pixels of an image of a value document 12 to be checked are to be considered as belonging to this manufacturing element or this print layer according to a specified criterion and which element template pixel data are to be used for ascertaining the template pixel data for the respective pixels for the value document image.

The background template is assigned only to the value document 12 as a whole and establishes which template pixel data is to be used for pixels that are not to be assigned or associated with one of the manufacturing elements or one of the print layers and are thus not included in any of the element templates. Such a background template therefore exists only once for a value document type.

The checking method is very schematically illustrated in FIG. 10.

As described at the beginning, value documents 12 to be checked are transported past the sensor unit 38 and thus the remission sensor 40 by the transport unit 18.

In step S20, for a value document transported past the remission sensor 40, a digital image of the value document, i.e. a value document image, is captured and, where applicable after preprocessing, is transmitted to the evaluation unit 47. There it provided in the memory 48 for checking. In such a pre-processing, for example, the actual image of the value document could be aligned, when the value document was not perfectly aligned relative to the remission sensor upon the capture of the value document image and, accordingly, the longitudinal and transverse edges are not parallel to the corresponding axes of the coordinate system.

In step S22, positions of the manufacturing elements are ascertained for the provided value document image, which is effected according to step S10.

In step S24, an individual template for the digital value document image is then generated using the element templates for the manufacturing elements and the ascertained positions of the manufacturing elements as well as the background template.

For this, the element templates for the manufacturing elements are displaced in accordance with to the ascertained positions of the respective manufacturing elements. So, in the example of the value document image in FIG. 3B, the element templates for the manufacturing element 64 in FIG. 3A would be displaced by the vector V from the place in FIG. 3A.

First, the first element templates are used. Pixels of the template, which are present in the first element templates displaced in accordance with the ascertained positions of the manufacturing elements, are assigned template pixel data which are ascertained in dependence on element template pixel data of the first element templates displaced in accordance with the ascertained positions of the manufacturing elements. More precisely, in the case where the pixel is present in only one of the displaced element templates, the corresponding element template pixel data is used for the pixel as template pixel data. If, on the other hand, the pixel in the value document is found in both element templates displaced according to the positions, the template pixel data is ascertained from the corresponding element template pixel data. In the example of a soiling check, as the lower limit, for example, the minimum of the element template pixel data of the corresponding pixels could be ascertained and as the upper limit the maximum.

For the remaining pixels of the template which are present in at least one of the second element templates displaced in accordance with the ascertained positions of the manufacturing elements, template pixel data is ascertained using the element template pixel data of a respective corresponding pixel of the at least one of the second element templates which are displaced in accordance with the ascertained positions of the manufacturing elements. The procedure is not fundamentally different from that for the first element templates.

Finally, for the remaining pixels of the template that are not present in the first or second element templates but only in the background template, template pixel data is respectively ascertained using the background template pixel data of a respectively corresponding pixel of the background template. With that, a complete template for the entire value document is present.

In step S26, the digital value document image is then checked using the ascertained template. For this, methods known in the art that require a template can be used. In a soiling check there can be checked, for example, whether the pixel data for the pixels of a value document image lie within an interval whose limits are given by the template pixel data of the corresponding pixel of the template. If the pixel data lies below the interval, there is soiling.

As a result, a signal can be emitted in step S28 that renders the result of the check.

A second embodiment example differs from the first embodiment example in that in the adaptation method, the assignment of the pixels to manufacturing elements and the subsequent creation of the element templates is modified. Steps S12 and S14 are replaced by steps S12′ and S14′. The adaptation method is very schematically illustrated in FIG. 11.

In step S12′, two assignments are carried out in the example, which differ in the size of the pixel environment and the assignment criterion. The respective ascertainment of the match degree is made analogously to the first embodiment example.

More precisely, a first assigning of the respective pixel of the training image is made taking into account the respective position of the manufacturing elements to one of the manufacturing elements in dependence on the ascertained first match degrees according to the specified first assignment criterion. The pixel environment is, for example, a 3×3 pixel environment of the pixel including the pixel.

For the second assigning or the second assignment, for pixels of the training image, a second degree of match of a second pixel environment of the respective pixel of the training image with a corresponding pixel environment of a corresponding pixel of the reference image is ascertained, taking into account the respective ascertained position of the manufacturing elements. The second pixel environment can be, for example, a 5×5 pixel environment.

The second assignment is made analogously to the first assignment, wherein the second assignment criterion may differ from the first assignment criterion by the choice of the minimum value. The minimum value can, however, also be selected as the same.

In the modified step S14′, the first and second element templates are generated based on these assignments.

More specifically, for each of the manufacturing elements, a first element template is generated using the corresponding first assignment, which includes those pixels that have been assigned to the respective manufacturing element in the first assignment in all the training images. As element template pixel data, an average value over the pixel data of the respective pixel in the training images is used. In other embodiment examples, the element template pixel data may also comprise a lower and upper limit for an interval of permissible values, which may be given by the minimum and the maximum of the pixel data of the respective pixel in the training images, respectively.

For each of the manufacturing elements, there is further generated a second element template using the corresponding second assignment, which includes those pixels that were assigned in at least one of the training images to the respective manufacturing element in the second assignment. As element template pixel data, an average value over the pixel data of the respective pixel in the training images is used. In other embodiment examples, the element template pixel data may also comprise a lower and upper limit for an interval of permissible values, which may be given by the minimum and the maximum of the pixel data of the respective pixel in the training images, respectively.

The other steps are unchanged compared to the first embodiment example.

The corresponding checking method remains unchanged, except for the use of the other element templates.

This variant is illustrated by the example of the value document type in FIG. 4.

The pixels included in the first element templates and the element template pixel data assigned to these pixels characterize points on the training value documents where the respective print layer is dominant, i.e. that the respective print layer overlays all other possibly present print layers at this point so that the other print layers are quasi not visible.

FIG. 5 (left) shows an example of an assignment of pixels to the first print layer (dark grey) or second print layer (light grey) made for a detail of an image of a training value document in FIG. 4 in a pixel environment of ±2 pixels. For black regions, no clear assignment to a print layer could be made.

FIG. 5 (right) shows an example of an assignment of pixels to the first print layer (dark grey) or second print layer (light grey) made for a part of a training value document in FIG. 4 in a pixel environment of ±10 pixels. For black regions, no clear assignment to a print layer could be made.

FIG. 6 shows respectively one example of a first element template (light grey) for the first print layer (left) and the second print layer (right) in a detail of the training value documents of the value document type in FIG. 4. Regions represented in black are not part of the respective first element templates.

FIG. 7 shows respectively one example of a second element template for the first print layer (left) and the second print layer (right) in a detail of the training value documents of the value document type in FIG. 4. The regions represented in white are not occupied by pixels of the respective second element template and thus also not by pixels of the first element template; they belong to the background template.

FIG. 8 shows an example of an individual template for a value document or value document image, which is composed of first and second element templates and a background template, which have or has preferably been generated in the method for generating templates described above.

Further embodiment examples differ from the previously described embodiment examples in that as element template pixel data and background template pixel data, values are used, that are a function of the pixel data of the corresponding pixels in the training images in which they were assigned to the manufacturing element and the background, respectively. For example, the values could be average values over the pixel data of the pixel. These templates could be suitable for a different type of soiling check, but also for an authenticity check. Possible acceptable tolerances during checking may be specified by the checking method.

In other embodiment examples, instead of interval limits, specified points of an interval, for example its center, and its length could be used as pixel data.

Still further embodiment examples may differ from the previously described embodiments in that the pixel surroundings may be selected to be greater. The selection may depend on the resolution of the digital images and the sizes of visible structures on value documents of the specified value document type.

Further embodiment examples differ from the previously described embodiment examples in that the control and evaluation unit 46 is divided into two parts, an evaluation unit corresponding to the evaluation unit 47 and a control device separate from the latter which receives signals from the evaluation unit and uses them for control.

In still other embodiment examples, the adaptation device may be part of a value document processing device. For example, the evaluation unit of the device of the first embodiment example could have a corresponding computer program that is executed in an adaptation mode of the value document processing device, in which no value documents are processed.

1.-23. (canceled)

24. A method for generating element templates for forming templates when checking value documents of a specified value document type, in particular bank notes,
wherein value documents of the specified value document type have at least two specified manufacturing elements, in particular print layers and/or security elements, which, where applicable partly, overlap each other, and the element templates correspond to the manufacturing elements,
wherein digital training images of training value documents of the specified value document type and a digital reference image of a reference value document of the specified value document type, which each have pixels to which pixel data are respectively assigned, are used, having the following steps:
for the training images, respectively ascertaining a position of the manufacturing elements, and
assigning pixels of the respective training image to the manufacturing elements using the reference image and taking into account the respectively ascertained positions of the manufacturing elements,
for each of the manufacturing elements, generating a first element template which includes those pixels that have been assigned to the respective manufacturing element in all the training images, and
for each of the manufacturing elements, generating a second element template which includes those pixels that have been assigned to the respective manufacturing element in one or several of the training images.

25. The method according to claim 24, in which the training value documents and the reference value document comprise or are preferably finished and/or freshly printed value documents of the specified value document type, in particular of the same currency and/or denomination.

26. The method according to claim 24 comprising the further step of:
generating a background template which includes those pixels that have not been assigned to any of the manufacturing elements in any of the training images and background template pixel data assigned thereto, respectively, which is ascertained from pixel data which are assigned to the respective pixels of the training images.

27. The method according to claim 24, in which, when ascertaining the position of the respective manufacturing elements in a respective one of the training images, the position is ascertained with respect to the same positional reference system or relative to at least one of the manufacturing elements in a specified one of the training images or relative to at least one of the manufacturing elements in the reference image.

28. The method according to claim 24, in which, when assigning pixels of the respective training image to the manufacturing elements for a respective pixel of the respective training image, a degree of match between a pixel environment of the pixel and a pixel environment of a corresponding pixel in the reference image are ascertained,
wherein the respective pixel environments of the respective pixel in the training image and in the reference image are offset in accordance with the respective relative position of the respective manufacturing element in the training image to that in the reference image, and the respective pixel of the training image is assigned to one of the manufacturing elements in dependence on the ascertained match degrees according to a specified assignment criterion.

29. The method according to claim 24, in which, when assigning pixels of the respective training image to the manufacturing elements for a respective pixel of the respective training image, a first degree of match between a first pixel environment of the pixel and a first pixel environment of a pixel in the reference image are ascertained,
wherein the first pixel environments in the training image and in the reference image are offset, in accordance with the respective relative position of the respective manufacturing element in the training image, to that in the reference image, and the respective pixel of the training image is assigned, in a first assignment, to one of the manufacturing elements in dependence on the ascertained first match degrees according to a specified first assignment criterion, and
for a respective pixel of the respective training image, a second degree of match between a second pixel environment of the pixel and a second pixel environment in the reference image is ascertained,
wherein the second pixel environments in the training image and in the reference image are offset, in accordance with the respective relative position of the respective manufacturing element in the training image, to that in the reference image, and the respective pixel of the training image is assigned, in a second assignment, to one of the manufacturing elements in dependence on the ascertained second match degrees according to a specified second assignment criterion, and the second pixel environments respectively comprise more pixels than the first pixel environments.

30. The method according to claim 29, in which the first element template for the respective manufacturing elements includes only those pixels which, in all the training images, were assigned to the respective manufacturing element in the first assignment, and
wherein the second element template for the respective manufacturing elements includes those pixels which, in at least one of the training images, were assigned to the respective manufacturing element in the second assignment.

31. The method according to claim 24, wherein, when generating the element templates, first element template pixel data is assigned to the pixels included in the first element template and second partial template pixel data is assigned to the pixels included in the second element template,
wherein the first and/or second element template pixel data is ascertained from pixel data assigned to the respective pixels of the training images or correspond to the pixel data assigned to the respective pixels of the training images.

32. The method according to claim 24, in which for providing the training images, digital images of several training value documents of the specified value document type are captured and/or for providing the reference image, a digital image of a reference value document of the specified value document type is captured.

33. A computer program with program code means for carrying out the method according to claim 24 when the program is executed on a computer.

34. A computer-readable data carrier with program code which is executable by a computer, so that the computer executes a method according to claim 24.

35. A method for checking value documents of a specified value document type, which respectively have two specified manufacturing elements, in particular print layers and/or security elements,
using element templates, generated in particular by means of a method according to claim 24, for the manufacturing elements, having the steps of:
providing a digital value document image of a value document of the specified value document type to be checked, which comprises the pixel which respectively have pixel data assigned thereto,
for the provided value document image, ascertaining a position of the manufacturing elements,
ascertaining a template for the digital value document image using the element templates for the manufacturing elements and the ascertained positions of the manufacturing elements,
checking the digital value document image using the ascertained template.

36. The method according to claim 35, in which, when ascertaining the template, pixels of the template that are present in the element templates displaced in accordance with the ascertained positions of the manufacturing elements are respectively assigned template pixel data that are ascertained for the manufacturing elements in dependence on element template pixel data of corresponding pixels of element templates displaced in accordance with the respectively ascertained positions.

37. The method according to claim 35, in which for at least one of the manufacturing elements, a first and a second element template are used,
in which, when ascertaining the template, to pixels of the template which are present in the first element templates displaced in accordance with the ascertained positions of the manufacturing elements, template pixel data are assigned which were ascertained using element template pixel data of the respective pixels in the first element templates displaced according to the ascertained positions of the manufacturing elements,
for the remaining pixels which are present in at least one of the second element templates displaced in accordance with the ascertained positions of the manufacturing elements, template pixel data is ascertained using the element template pixel data of respectively corresponding pixels of the at least one of the second element templates displaced in accordance with the ascertained positions of the manufacturing elements.

38. The method according to claim 35, in which a background template is used that includes pixels which are not included in any of the element templates for the manufacturing elements, and
in which, when ascertaining the template for the digital value document image, for the remaining pixels which are present in the background template, template pixel data is respectively ascertained using the element template pixel data of a respective corresponding pixel of the background template.

39. The method according to claim 35, in which when providing the value document image, a digital value document image of a value document to be checked is captured by means of an image capture unit and stored in a memory unit.

40. A method for processing, in particular checking and/or counting and/or sorting and/or destroying, value documents of a specified value document type which respectively have two specified manufacturing elements, in particular print layers and/or security elements, in which value documents are individually transported past an image capture unit for capturing a digital value document image, a digital value document image is captured during the transport of a respective value document past the unit, and is then checked, in real time, with a method according to claim 35.

41. A computer program with program code means for carrying out the method according to claim 35 when the program is executed on a computer.

42. A computer-readable data carrier with program code which is executable by a computer, so that the computer executes a method according to claim 35.

43. A device for generating element templates for forming templates when checking value documents of a specified value document type,
wherein value documents of the specified value document type have at least two specified manufacturing elements, in particular print layers and/or security elements, which, where applicable, partially overlap each other, with a memory unit for storing digital training images of the specified value document type, a reference image of a reference value document of the specified value document type and generated element templates,
wherein the device is configured to carry out a method according to claim 24 using the training images and the reference image and to store the generated element templates in the memory unit.

44. A device for checking value documents, in particular bank notes, which respectively have at least two specified manufacturing elements, in particular print layers and/or security elements, using element templates for the manufacturing elements, in particular generated in a method according to claim 35, comprising:
an evaluation unit which has at least one memory in which the element templates are stored and an interface for providing a digital value document image,
wherein the evaluation unit is adapted to carry out the method for the manufacturing elements.

45. The device according to claim 44, which further has an image capture unit for capturing a digital value document image of a value document to be checked, which is connected to the interface for providing a digital value document via a signal connection.

46. A device for processing, in particular checking and/or counting and/or sorting and/or destroying, value documents of a specified value document type, in particular bank notes which respectively have at least two specified manufacturing elements, in particular print layers and/or security elements, comprising
a feeding unit for feeding individual or singled value documents to be processed,
an output unit with at least one output portion for receiving processed value documents,
a transport unit for transporting individual or singled value documents from the feeding unit to the output unit, and
a checking device according to claim 44,
wherein the image capture unit of the checking device is arranged at the transport path and is adapted in such a way that digital value document images of value documents to be checked which are transported past the image capture unit are captured during the transport and are provided for use in the checking device.
